(19) United States
(12) Patent Application Publication
(10) Pub. No.: US 2025/0314311 A1
(43) Pub. Date: Oct. 9, 2025

(54) VALVE ARRANGEMENT FOR A MULTI-PORT VALVE

(71) Applicant: OTTO EGELHOF GmbH & Co. KG, Fellbach (DE)

(72) Inventors: Jean-Jacques Robin, Berglen (DE); Robin Bopp, Lorch (DE); Eike Willers, Stuttgart (DE)

(21) Appl. No.: 19/169,406

(22) Filed: Apr. 3, 2025

(30) Foreign Application Priority Data
Apr. 5, 2024 (DE) 10 2024 109 600.4
Mar. 5, 2025 (DE) 10 2025 108 331.2

(51) Int. Cl. F16K 11/07

(52) U.S. Cl. CPC F16K 11/0712

(57) ABSTRACT

A valve arrangement for a multi-port valve, with a connection point, in which an inlet and at least a first and a second outlet are provided. A stroke movement of the valve body along a stroke axis in the connection point is controllable by an actuating element of a drive. The valve body is tubular, and the valve body is arrangeable in a first end position, in which a first passage is closed, and in a second end position, in which a second passage is closed. The valve body is displaceably guided by at least one seal, which is arranged between the first and second end positions.

This application claims priority of German Application No. 10 2024 109 600.4 filed Apr. 5, 2024, and German Application No. 10 2025 108 331.2, filed Mar. 5, 2025, both of which are incorporated herein by reference in their entireties.

The invention relates to a valve arrangement for controlling a medium, in particular in a refrigerant circuit of a refrigeration system with a heat pump function.

DE 10 2017 102 841 A1 discloses a multi-port valve for controlling a refrigerant circuit of a refrigeration system with heat pump function. This multi-port valve comprises a housing with an inlet which is connected to a fluid channel with a regulating chamber in the housing. Furthermore, the housing comprises a first and second outlet opening, which are also connected to the regulating chamber. A rotary slide valve arrangement is provided in the regulating chamber, which comprises a first control disk and a second control disk. At least the first control disk of the rotary slide valve arrangement is actuated by a drive, so that the first and/or second outlet opening can be controlled as required. The control disks of the rotary slide valve arrangement are made of a wear-resistant and low-friction material, such as ceramic. The requirements for a simple design and lower actuating forces as well as a reduction in the construction volume are constantly increasing.

The invention is based on the task of proposing a valve arrangement for controlling a medium, in particular in a refrigerant circuit of a refrigeration system with a heat pump function, which has a simple design and in which a valve body is actuatable with low actuating forces.

This task is solved by a valve arrangement for a multi-port valve, in which a first passage is formed between the inlet and the first outlet and a second passage is formed between the inlet and the second outlet, wherein a valve body is formed tubular, which closes the first outlet in a first end position of a stroke movement and closes the second outlet in a second end position, wherein the valve body is guided displaceably with at least one seal during the stroke movement between the two end positions. This arrangement enables a structurally simple design, in which the valve body is moveable between the two end positions by a stroke movement, in particular along the stroke axis. This enables a simple control of a refrigerant from the inlet to the first or second outlet.

Preferably, the tubular valve body has a first valve closing member which opens and closes a first passage between the inlet and the first outlet and a second valve closing member which opens and closes a second passage between the inlet and the second outlet. This means that the opening and closing of the first or second passage can be controlled by a stroke movement of the valve body. The two valve closing elements are preferably formed on the tubular valve body so that a refrigerant can only escape in the axial direction and not in the radial direction between the two valve closing elements.

According to a further preferred embodiment of the valve arrangement, it can be provided that the valve body is transferrable to an intermediate position during a movement between the first and second end positions, in which the inlet and the two outlets are connected to each other. This arrangement allows the refrigerant to flow from the inlet into both the first and the second outlet. In the intermediate position, the volume flow can also be controlled in such a way that, for example, a higher volume flow is transferred to one outlet than to the other outlet.

The tubular valve body preferably has a cylindrical section that is slidably accommodated by the seal. A dynamic seal is preferably provided. This enables a structurally simple design of the valve body.

Preferably, the cylindrical section of the valve body has a length so that the valve body is guided by the seal during the stroke movement between the first and second end positions. Consequently, the length of the cylindrical section can be adapted to the structural conditions and yet a simple design of the seal, preferably between the first and second passage, can be maintained.

The valve body advantageously has a valve closing element at the respective end of the cylindrical section. This allows one valve closing member to open a passageway and the other valve closing member, particularly the opposite one, to close a passageway at the same time as a result of the stroke movement. Preferably, the valve closing members are mirror-symmetrical to the cylindrical section of the valve body.

A first valve seat is preferably formed in the first passage between the inlet and the first outlet and a second valve seat is formed in the second passage between the inlet and the second outlet. This allows the valve body to alternately close one or the other passage by positioning the respective valve closing element in the valve seat.

The valve closing element preferably has a conical closing body that tapers or widens towards the end face of the tubular valve body. In both cases, the end positions described above can be actuated to control the refrigerant.

According to a first embodiment, a tapered conical closing body is provided towards the respective end face of the valve body. Preferably, the closing body is formed in one piece with the cylindrical section of the valve body. According to a second embodiment, it may be provided that a widening conical closing body is provided at the respective end face of the valve body. In this embodiment, the valve body is formed in at least two parts, with a separation point preferably being formed in a central cylindrical section of the valve body.

In particular, it is provided, that the valve closing elements have the same geometry. As a result, the same gradient of the characteristic curve for the flow volume can be achieved for both valve closing elements. As a result, the same conditions for opening and closing, in particular forces acting due to the pressure of the refrigerant in the refrigerant circuit, can prevail both when positioning the valve body in the first end position and in the second end position. This embodiment also has the advantage that the drive does not have to be designed differently for the respective opening and closing movement of the respective valve closing member.

A valve seat is provided in each of the first and second passage, which has a radial sealing surface. This radial sealing surface advantageously interacts with the conical closing body of the valve closing element, in particular to achieve a seat tightness.

An inside diameter of the seal, which engages with the cylindrical section of the valve body, and an inside diameter of the sealing surface of the valve seat are preferably the same. This ensures that the same force ratios are present during an opening and closing movement of the valve body.

It may also be provided that the inside diameter of the sealing surface of the valve closing member is smaller than the inside diameter of the seal in the case of a valve closing member that tapers towards the end faces of the valve body. In particular, it is provided that the diameter of the sealing surface of the valve seat comprises at least 95%, in particular at least 99%, of the inside diameter of the seal. This enables only a small gap to be created between the conical valve closing member and the radial sealing surface of the valve seat during a stroke movement of the valve body from a closed position. The smaller the annular gap, the lower the force that has to be applied for a lifting movement of the valve body in order to move it from a closed position to an open position

It is also provided that, in the case of a valve closing member widening towards the end faces of the valve body, an inside diameter of the radial sealing surface of the valve seat is larger than an inside diameter of the seal, in particular the inside diameter of the radial sealing surface comprises at most 105%, in particular less than 101% of the diameter of the seal.

Advantageously, it is provided that at least the conical closing body and the sealing surface of the valve seat are made of metal. In particular, it is envisaged that the entire valve body is made of metal. This design has the advantage that a high seat tightness can be achieved between the closing body and the sealing surface with a simultaneous clamping effect between the closing body of the valve closing member and the sealing surface of the valve seat. As a result, no additional components are required to keep the conical closing body in a tight arrangement to the sealing surface of the valve seat.

A further preferred embodiment of the valve arrangement is that the first and second valve seat can be inserted into the passage of the connection point and the seal is arranged between the first and second valve seat. This enables a simple structure and accommodation of the seal as a dynamic ring seal and completion of the valve arrangement.

Preferably, the first and second valve seats are designed separately from each other and the seal for guiding the valve body is positioned and accommodated at a connection point between the first and second valve seats. This makes it easy to fit the seal between the two valve seats.

The invention and other advantageous embodiments and further embodiments thereof are described and explained in more detail below with reference to the examples shown in the drawings. The features to be taken from the description and the drawings can be used individually or in any combination in accordance with the invention. It shows:

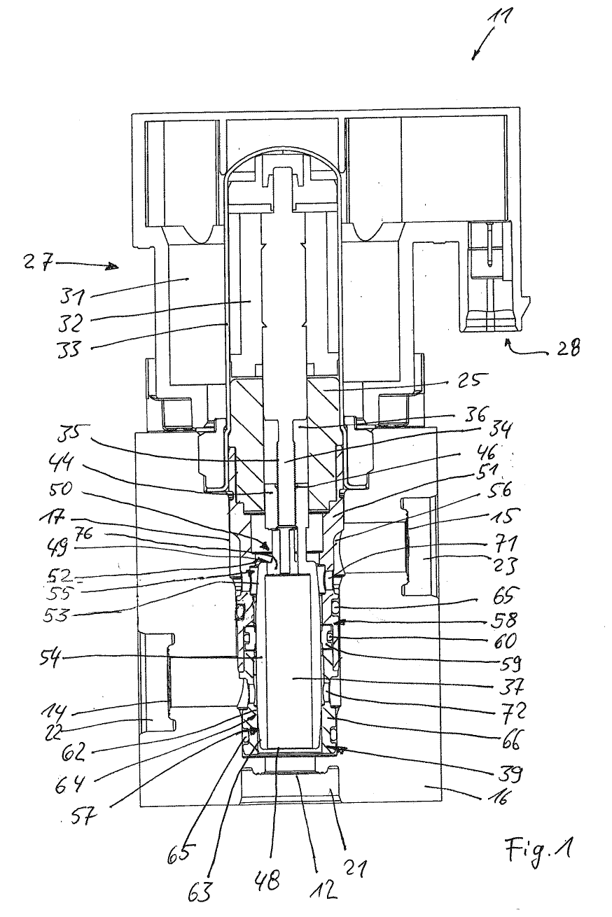

FIG. 1 a schematic sectional view of a first embodiment of a valve arrangement with a valve body in a first end position,

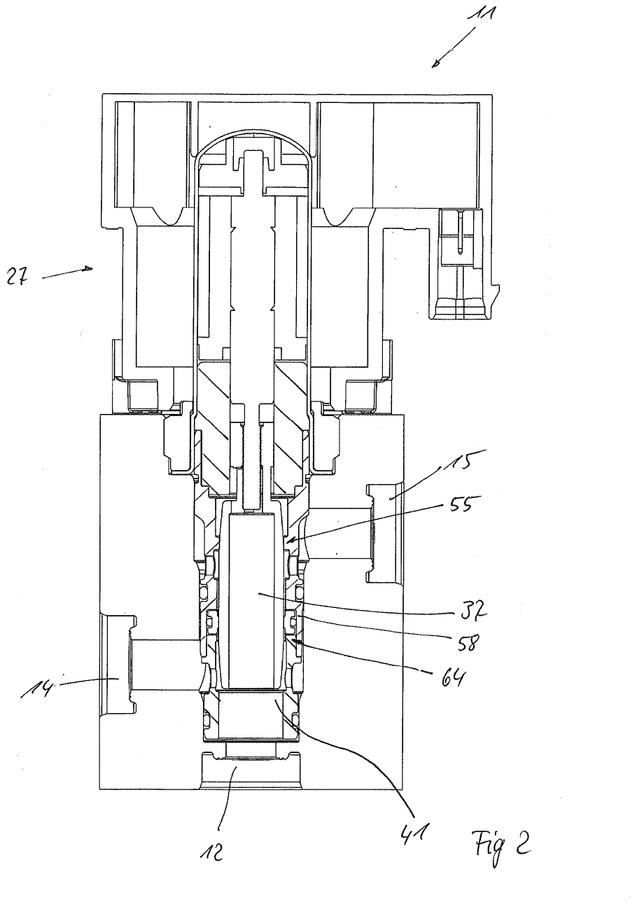

FIG. 2 a schematic sectional view of the embodiment according to FIG. 1 with the valve body in a second end position,

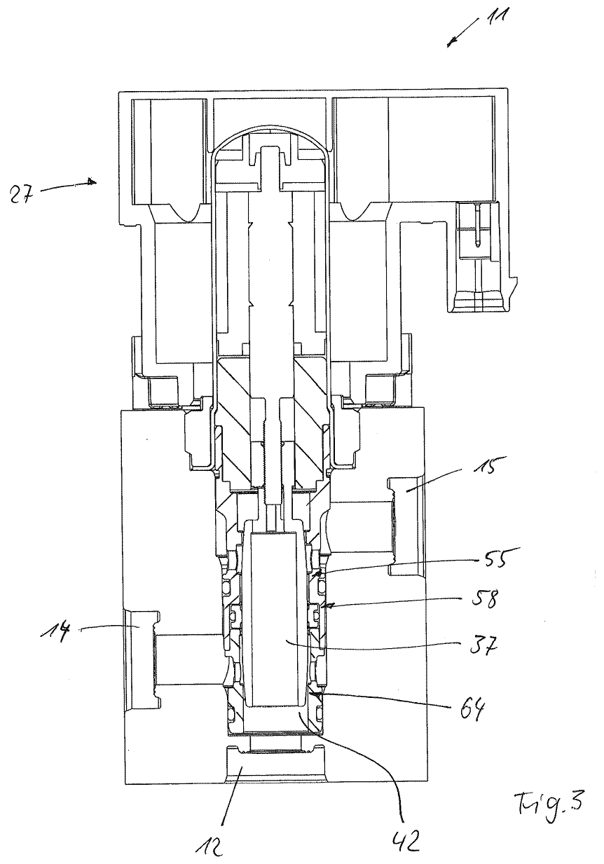

FIG. 3 a schematic sectional view of the embodiment according to FIG. 1 with the valve body in an intermediate position,

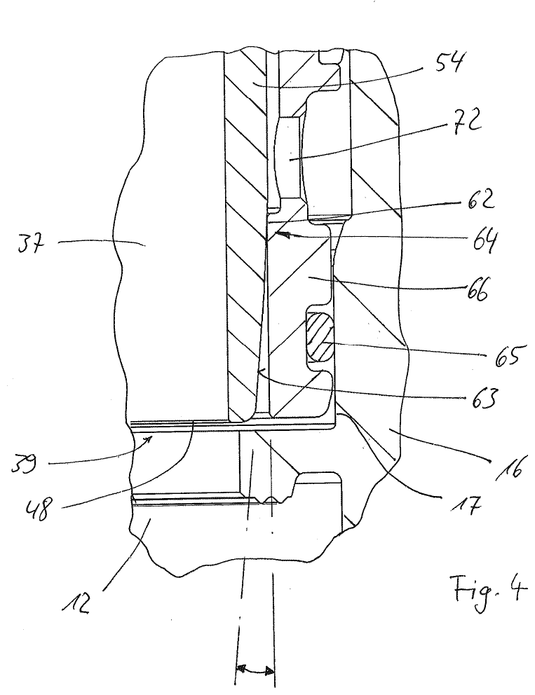

FIG. 4 a schematically enlarged view of the valve body of the valve arrangement according to FIG. 1,

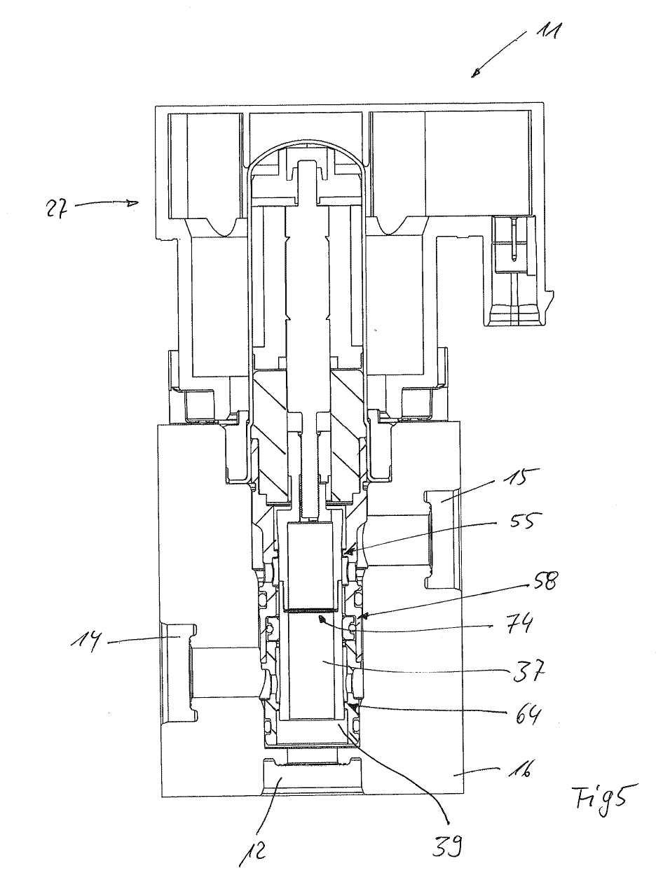

FIG. 5 a schematic sectional view of a second embodiment of a valve arrangement with a valve body in a first end position,

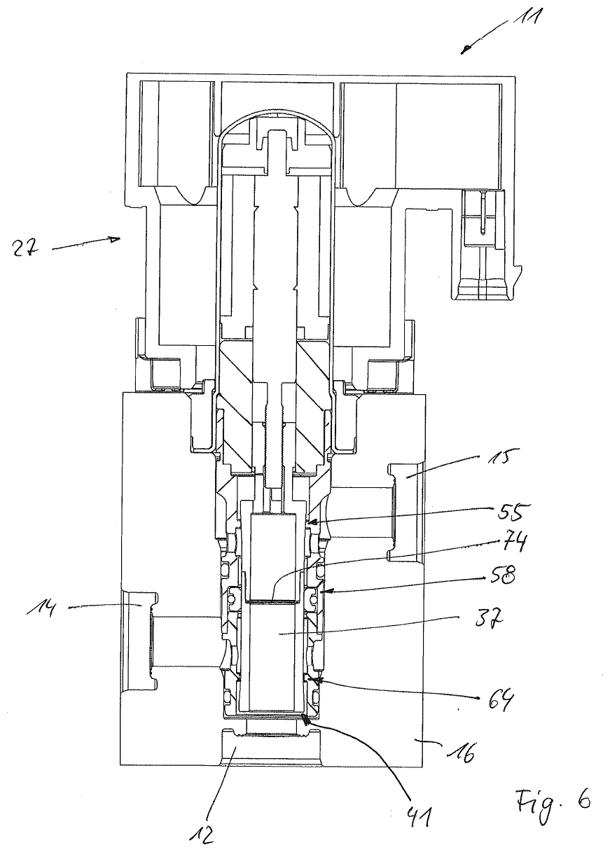

FIG. 6 a schematic sectional view of the second embodiment according to FIG. 5 with the valve body in a second end position,

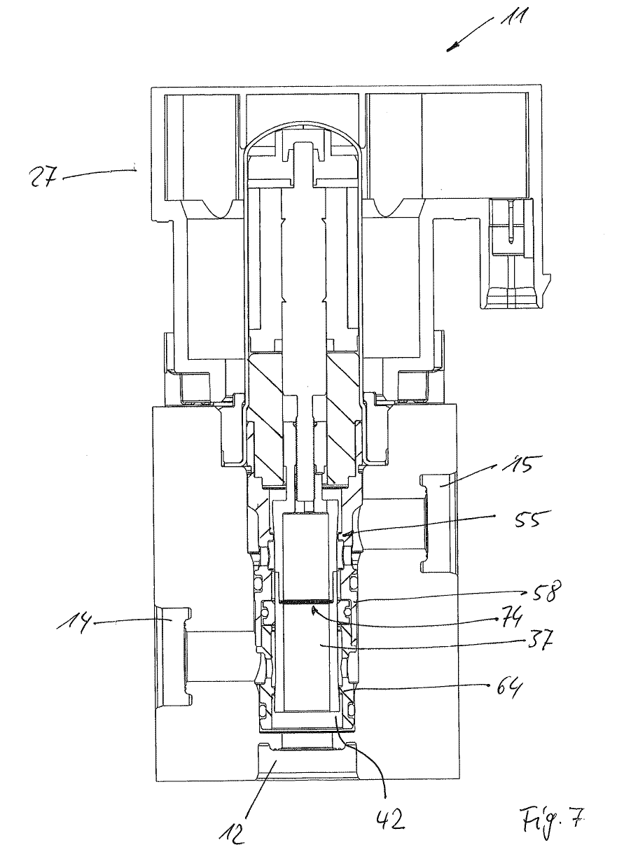

FIG. 7 a schematic sectional view of the second embodiment according to FIG. 5 with the valve body in an intermediate position,

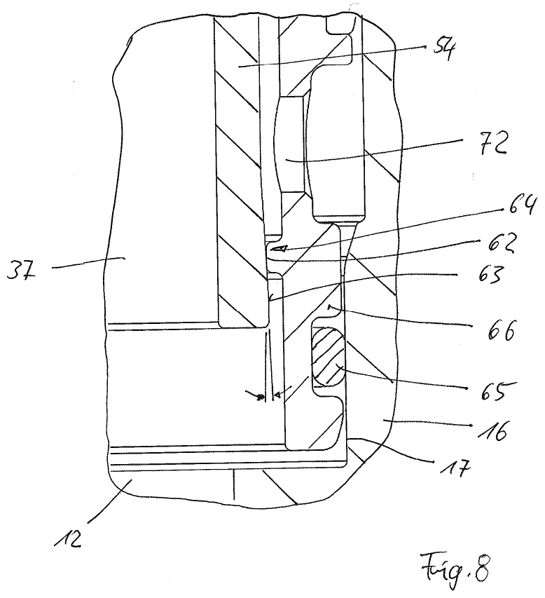

FIG. 8 a schematically enlarged view of the valve body of the valve arrangement according to FIG. 5, and

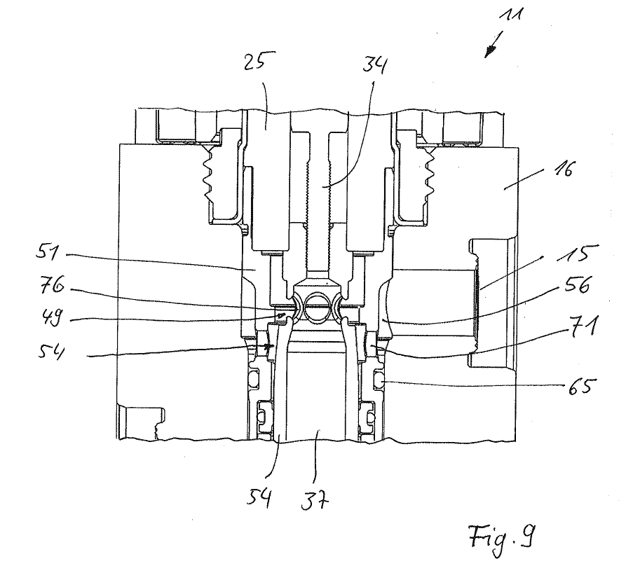

FIG. 9 a schematically enlarged detailed view of an alternative embodiment of the valve body.

FIG. 1 shows a schematic sectional view of a multi-port valve 11. This multi-port valve 11 can be used to control a refrigerant circuit of a refrigeration system with a heat pump function. This multi-port valve 11 is designed, for example, as a three-way valve, which comprises an inlet 12 and a first outlet 14 as well as a second outlet 15. Alternatively, the multi-port valve 11 can also have several inlets and/or outlets.

The multi-port valve 11 is shown as an example in an installed position in a connection point 16. This connection point 16 comprises an insertion opening 17 into which the multi-port valve 11 can be inserted and connected to the connection point 16, in particular fastened with a detachable screw connection. An inlet opening 21 and a first and second outlet opening 22, 23 are provided in the connection point 16. The inlet opening 21 and the first and second outlet openings 22, 23 open into the insertion opening 17. This insertion opening 17 can also form a regulating chamber, which connects the inlet 12 and the first outlet 14 and the second outlet 15 to one another.

The multi-port valve 11 comprises a valve housing 25. This valve housing 25 is connected to an actuator 27. The actuator 27 is designed as an electrically controllable actuator 27. A connection 28 is provided for this purpose. This connection 28 can be used for the power supply and/or for data transmission of electronics in the actuator 27, which are not shown in detail. The drive 27 is designed, for example, as a separating cap motor. It is preferable that the electronics of the drive 27 enable precise control of a stroke movement of a valve body 37. This control can be step-by-step or continuous. This makes it possible to control and assume a defined stroke position of the valve body 37. This actuator 27 comprises a fixed stator 31 and a rotor 32 that can be driven in rotation. A separating cap 33 is arranged between the stator 31 and the rotor 32. The separating cap 33 is arranged media-tight to the connection point 16 or to the insertion opening 17. The rotor 32 drives an actuating element 34 in rotation. The adjusting element 34 has a thread 35 on its outer circumference. The adjusting element 34 is secured in its position axially to the rotor 32 and rotates about its longitudinal axis. Alternatively, a proportional magnetic drive, in particular with a magnetic armature position control, or other electrically controllable drives can be provided.

The actuating element 34 extends through the valve housing 25. In particular, this actuating element 34 is positioned in a valve body chamber 36. The actuating element 34 is connected to a valve body 37. The valve body 37 is subjected to a stroke movement along its longitudinal axis by the actuating element 34 or the drive 27. The valve body 37 can be moved by the drive 27 from a first end position 39, which is shown for example in FIG. 1, to a second end position 41, which is shown in FIG. 2. In addition, the drive 27 also enables the valve body 37 to be moved to one or more intermediate positions 42, an intermediate position 42 being shown as an example in FIG. 3.

The valve body 37 is secured against rotation relative to the control element 34 by an anti-rotation device 44. The anti-rotation device 44 can be moved within the valve body chamber 36. For example, a flattened portion or a spring, which is guided in a groove of the valve body chamber 36, or the like is provided on the outer circumference of the anti-rotation device 44.

A pressure bypass 46 is provided between the valve body 37 and the valve body chamber 36. This pressure bypass 46 is formed between the thread 35 of the actuating element 34 and the anti-rotation device 44, for example as a flattening on the actuating element 34. The pressure bypass 46 can also be formed between the anti-rotation device 44 and the valve body chamber 36.

The valve body 37 is tubular in shape. The valve body 37 can be made of a plastic. The valve body 37 can also be made of a light metal alloy and other materials which are suitable for the use of various refrigerants. One end section of the valve body 37 is connected to the adjusting element 34 or the anti-rotation device 44. The valve body 37 has two through openings 48, 49. In the embodiment example, a first passage opening 48 is provided at the end face end of the tubular valve body 37. The further or second passage opening 49 is provided opposite. The second passage opening 49 is formed, for example, by a cage 50, which has, for example, several individual openings 76, which are separated in particular by webs. The actuating element 34 can extend within the cage 50 provided at the end of the valve body 37 depending on the stroke position of the valve body 37. The passage openings 48, 49 can, for example, be designed as circular openings. They can also be polygonal or rectangular. A combination can also be possible in the cage 50, for example.

The valve body 37 has a first valve closing element 63. The second valve closing member 53 is provided at its end facing the actuator 27. This second valve closing member 53 is in the form of a taper or cone which tapers in the direction of the cage 50 or the drive 27. A first valve closing member 63 is formed opposite this second valve closing member 53. This first valve closing member 63 is also designed in the form of a cone or taper, which tapers in the direction of the passage opening 48 or in the direction of the inlet 12. Between the second valve closing member 53 and the first valve closing member 63, the valve body 37 has a cylindrical section 54. The second valve closing member 53, the cylindrical section 54 and the first valve closing member 63 are preferably formed in one piece. Within the second valve closing member 53, the cylindrical section 54 and the first valve closing member 63, a passage extends from the first passage opening 48 to the second passage opening 49.

Surrounding the valve body 37 and adjacent to the valve housing 25, a sleeve is provided which has a first and a second valve chamber sleeve 66, 51. These two valve chamber sleeves 51, 66 are connected to each other, for example by a plug-in connection, which can be inserted and positioned in the insertion opening 17 of the connection point 16. At least one seal 65 is provided on an outer circumference of the first valve chamber sleeve 66 and the second valve chamber sleeve 51 for the sealing arrangement of the valve chamber sleeves 51, 66. The first and second valve chamber sleeves 66, 51 are preferably tubular in shape. The first valve chamber sleeve 66 surrounds the first valve closing member 63. The second valve chamber sleeve 51 surrounds at least the second valve closing member 53 and can surround a region of the cylindrical section 54. The second valve chamber sleeve 51 is preferably detachably attached to the valve housing 25. In addition, a seal can be provided in between. A second valve seat 52 is formed on an inner circumference of the second valve chamber sleeve 51. This second valve seat 52 and the second valve closing member 53 form a second valve 55, which is opened or closed depending on the stroke movement of the valve body 37.

The first valve chamber sleeve 66 is positioned in the insertion opening 17 associated with the inlet 12. A first valve seat 62 is formed on an inner circumference of the first valve chamber sleeve 66, which surrounds the first valve closing member 63.

A seal 58 is positioned between the first valve chamber sleeve 66 and the second valve chamber sleeve 51. This seal 58 is held by the plug-in or screw connection between the first valve chamber sleeve 51 and the second valve chamber sleeve 51. This seal 58 surrounds the cylindrical section 54 of the valve body 37 and lies against it in a sealing manner. The cylindrical section 54 of the valve body 37 is axially displaceably guided by the seal 58.

The upper and lower valve seats 52, 62 are preferably formed identically, and in particular with respect to an axis of symmetry which can extend through the seal 58.

The first valve chamber sleeve 66 has a first passage opening 72 between the first valve seat 64 and the seal 58, which leads into a first pressure chamber 57, which is connected to the first outlet 14. Similarly, a second passage opening 71 is provided between the second valve seat 52 and the seal 58, which opens into the second pressure chamber 56, which is connected to the second outlet 15.

In this embodiment, the valve body 37 is formed in one piece and a two-piece sleeve is formed comprising the first valve chamber sleeve 66 and the second valve chamber sleeve 51 to enable assembly so that a first valve 64 and a second valve 55 are formed on the valve body 37 together with the sleeve.

In FIG. 1, the valve body 37 of the multi-port valve 11 is shown in the first end position 39 in the connection point 16 and thus in a first switching position. In this first switching position, the first valve 64 is closed and the second valve 55 is open. Consequently, the inlet 12 is in communication with the first passage opening 48 and the second passage opening 49 as well as the second pressure chamber 56, so that the refrigerant is transferred from the inlet 12 to the second outlet 15.

Due to this arrangement of the multi-port valve 11 according to FIG. 1, it is also possible for the pressure of the medium applied to the inlet 12 to be applied to the valve body chamber 36 via the pressure bypass 46. Based on this, a reduced actuating force of the actuator 27 is required to move the valve body 37 from a first end position 39 according to FIG. 1 to the second end position 41 according to FIG. 2.

FIG. 2 shows the valve body 37 in the second end position 41. Here, it is intended that the first valve 64 is open and the second valve 55 is closed. In this second switching position, the inlet 12 is therefore connected to the first passage opening 48 and the first pressure chamber 57, so that the refrigerant is transferred from the inlet 12 to the first outlet 14. The refrigerant, which is present in the valve body 37 up to the actuator 27 and exits through the cage 50, does not enter the second passage opening 71 and the second pressure chamber 56 due to the closed second valve 55. This flow path is blocked. The refrigerant can also not flow outside the valve body 37 from the inlet 12 in the direction of the second outlet 15, as the seal 58 is in sealing contact with the cylindrical section 54 of the valve body 37.

In FIG. 3, the valve body 37 is arranged in an intermediate position 42. In this intermediate position 42, both the first valve 64 and the second valve 55 are open. This enables the refrigerant to be transferred from the inlet 12 with a first partial flow into the first outlet 14 and with a second partial flow into the second outlet 15. If the valve body 37 is moved closer in the direction of the first end position 39, but the first valve 64 is not yet closed, the volume of the first partial flow to the first outlet 14 is less than that of the second partial flow to the second outlet 15. The same applies if the valve body 37 is moved closer in the direction of the second end position 41. Thus, depending on the stroke movement of the valve body 37 between the 1st end position 39 and the 2nd end position 41, one volume of the 1st partial flow and one volume of the 2nd partial flow can be controlled.

FIG. 4 shows a schematic enlargement of the first valve 64. The second valve 55 has a similar structure, so that the explanations in FIG. 4 also apply to the second valve 55. The first valve seat 62 is formed on a cylindrical inner circumference of the first valve chamber sleeve 66. The first valve closing member 63 is formed at an end face end of the valve body 37, which is associated with the first passage opening 48. The first valve closing member 63 has a course which tapers from the cylindrical section 54 towards the free end. The valve closing member 63 can have a conical shape, whereby the cone has a constant pitch, i.e. runs in a straight line. Alternatively, a parabolic course of the curvature of the valve closing member 63 can also be provided, in particular that the characteristic curve of the curvature comprises a course of a quadratic function. The valve closing member 63 can also have two or more conical sections arranged in a row with an increasing angle starting from the cylindrical section 54.

In particular, when the valve 64 is closed, the first valve closing member 63 is positioned in the first valve seat 62 with a slight clamping effect. This enables an internal (seat) tightness. In addition, an additional spring for the necessary closing force can be omitted. In particular, it is provided that both the valve body 37 and the valve chamber sleeve 66 are metallic.

FIGS. 5 to 8 show an alternative embodiment of the multi-port valve 11 to FIGS. 1 to 4. In this embodiment according to FIGS. 5 to 8, the first and second valves 55, 64 are designed differently from the first embodiment according to FIGS. 1 to 4. In this respect, only the deviations are described below. In all other respects, reference is made in full to the explanations of FIGS. 1 to 4.

In the valve body 37, it is provided that the respective first and second valve closing members 63, 53 arranged at the end section of the valve body 37 widen, i.e. do not taper. The first valve closing member 63 thus widens towards the first passage opening 48 in relation to the outer circumference. The second valve closing member 53 widens on the outer circumference when viewed in the direction of the second passage opening 49. The first and second valve closing members 63, 53 preferably have the same cone or the same cone shape as in the embodiment according to FIG. 4. In particular, the cone of the first and second valve closing member 63, 53 has the same shape.

The cylindrical section 54 is again formed on the valve body 37 between the first and second valve closing members 63, 53. In this embodiment, however, it is provided that the valve body 37 is advantageously formed in two parts. This can also be formed in several parts. Preferably, the at least one separation point 74 is formed in the region of the cylindrical section 54 of the valve body 37. This can be a plug connection, press connection or screw connection or the like.

The valve seat 52, 62 is adapted in such a way that it is designed in the form of an annular collar which protrudes inwards, i.e. radially inwards, with respect to an inner diameter of the first valve chamber sleeve 66 and the second valve chamber sleeve 51. A valve seat surface is formed radially circumferentially as a cylindrical section and is aligned with the outer circumference of the valve body 37.

Both the first embodiment and the second embodiment comprise a valve body 37, each comprising two valve closing members 53, 63, which are separated from each other by the cylindrical section 54 and are preferably formed symmetrically with respect to a center plane of the cylindrical section 54.

FIG. 9 shows a schematic enlargement of an alternative embodiment of the valve body 37. This alternative embodiment in FIG. 9 differs from the embodiments in FIGS. 1 to 3 in that, instead of a cage 50 to form the second passage opening 49, radially aligned individual openings 76 are formed. These individual openings 76 preferably lie in a common plane at right angles to the longitudinal axis of the valve body 37. These individual openings 76 are preferably circular and can, for example, be separated from one another by webs. Due to this arrangement of the radial individual openings 76, a large flow cross-section is provided for exchanging the flow medium between the interior of the valve body 37 and the exterior of the valve body 37. In addition, the explanations in FIGS. 1 to 4 also apply by analogy to the valve body 37 shown in FIG. 9.

1. Valve arrangement for a multi-port valve,
with a connection point, in which an inlet and at least a first and a second outlet are provided, which are connected to one another,
wherein a first passage is formed at least between the inlet and the first outlet and a second passage is formed between the inlet and the second outlet,
with a valve body, a stroke movement of the valve body along a stroke axis in the connection point is controllable by an actuating element of a drive,
wherein
the valve body is tubular, and
the valve body is arrangeable in a first end position, in which the first passage is closed, and in a second end position, in which the second passage is closed, by the stroke movement, wherein the valve body is displaceably guided by at least one seal, which is arranged between the first and second end positions.

2. Valve arrangement according to claim 1, wherein the tubular valve body has a first valve closing member which opens and closes a first valve, and a second valve closing member which opens and closes a second valve.

3. Valve arrangement according to claim 1, wherein the valve body closes the first outlet in the first end position by the first valve and opens the second outlet by the second valve and closes the second outlet in the second end position and opens the first outlet.

4. Valve arrangement according to claim 1, wherein the valve body is moveable into an intermediate position between the first end position and the second end position, in which the inlet is connected to the first and second outlet.

5. Valve arrangement according to claim 1, wherein the tubular valve body has a cylindrical section which is displaceably received by the seal, and the cylindrical section of the valve body has a length such that the valve body is displaceably guided by the seal between the first and second end position.

6. Valve arrangement according to claim 5, wherein the first valve closing member is formed at one end of the cylindrical section of the valve body and the second valve closing member is formed at the opposite end of the cylindrical section.

7. Valve arrangement according to claim 1, wherein a first valve is formed in the first passage between the inlet and the first outlet and a second valve is formed in the second passage between the inlet and the second outlet.

8. Valve arrangement according to claim 2, wherein the at least one valve closing member has a conical closing body which tapers or widens towards the end face of the tubular valve body.

9. Valve arrangement according to claim 8, wherein the valve body is formed in one piece with the tapering valve closing members, or the valve body is formed in two or more parts with the widening valve closing members.

10. Valve arrangement according to claim 9, wherein at least one separation point of the valve body with the widening valve closing members is formed in the region of the cylindrical section of the valve body.

11. Valve arrangement according to claim 8, wherein the opposing valve closing members are designed in mirror image to the cylindrical section of the valve body and symmetrically to a central plane of the valve body.

12. Valve arrangement according to claim 6, wherein the valve seat of the first and second valves have a radial sealing surface.

13. Valve arrangement according to claim 12, wherein an inner diameter of the seal and an inner diameter of the radial sealing surface of the valve seat are the same or almost the same.

14. Valve arrangement according to claim 12, wherein in the case of a valve closing member tapering towards the end faces of the valve body, an inside diameter of the radial sealing surface of the valve seat is smaller than an inside diameter of the seal.

15. Valve arrangement according to claim 14, wherein the inside diameter of the radial sealing surface comprises at least 95 percent of the diameter of the seal.

16. Valve arrangement according to claim 12, wherein in the case of a valve closing member widening towards the end faces of the valve body, an inside diameter of the radial sealing surface of the valve seat is larger than an inside diameter of the seal.

17. Valve arrangement according to claim 12, wherein the inside diameter of the radial sealing surface comprises at most 105% of the diameter of the seal.

18. Valve arrangement according to claim 7, wherein at least the valve closing member and the radial sealing surface of the valve seat are made of metal.

19. Valve arrangement according to claim 1, wherein the first valve seat is arranged in a first valve chamber sleeve and the second valve seat is arranged in a second valve chamber sleeve.

20. Valve arrangement according to claim 19, wherein at least one seal bearing against the valve body is positioned between the first and second valve chamber sleeve.
